(19) United States
(12) Patent Application Publication
(10) Pub. No.: US 2002/0059283 A1
(43) Pub. Date: May 16, 2002

(54) Method and system for managing customer relations

(75) Inventors: Barry Thomas Shapiro, Franklin, MI (US); Anita Marie Sharpe, Lapeer, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: EnterActLLC

(21) Appl. No.: 09/982,057

(22) Filed: Oct. 18, 2001

Related U.S. Application Data
(60) Provisional application No. 60/242,229, filed on Oct. 20, 2000.

(51) Int. Cl. G06F 7/00

(52) U.S. Cl. 707/100

(57) ABSTRACT

The present invention relates to a highly customizable CRM system that can: utilize iterative scripts to interact with existing and potential customers (collectively “customers”). Customer responses to scripted questions can be stored and ranked in a database. The invention supports decision trees automatically linking future actions to feedback provided by the customer. Numerical values can be attributed to customer responses in accordance with predetermined criteria set by the user. An overall customer value can be generated from the aggregate responses of a customer. A customer rating can be generated by applying the customer value to a predetermined threshold. Decision trees can also link response values, customer values, and customer ratings to future customizable events. Decision trees can be embedded in a particular script, and decision trees can also span across several different scripts. The invention utilizes a database incorporated vertically-based database tables; a structure that supports the ability to easily add database columns.

### RELATED APPLICATIONS

This application claims the benefit of the U.S. provisional application titled “A METHOD AND SYSTEM FOR MANAGING CUSTOMER RELATIONS OVER A NETWORK,” Serial No. 60/242,229, filed on Oct. 20, 2000, the contents of which are hereby incorporated by reference in their entirety.

### BACKGROUND OF THE INVENTION

The present invention relates in general to customer relationship management (“CRM”) systems. In particular, the present invention relates to a CRM system that: can utilize highly customizable, interactive and iterative scripts to interact with existing and potential customers (collectively “customers”) in a methodical manner, automatically scheduling follow-up behaviors based on the nature of the customer's feedback.

There are many computerized techniques on behalf of businesses that have been developed over the years to manage various aspects of the sales and selling cycle. These processes include telemarketing, contact management, direct mail, and CRM systems.

Telemarketing is used by sales persons to telephone current and prospective customers to gather information and promote sales. Often questions and comments to be directed at the recipient are stored in computers. These questions are displayed to the caller to prompt him/her as which comment or questions to ask. Answers can also stored in the computer. Telemarketing can be an effective sales tool, but it tends to isolate sales activity from other relationship building activities with the customer. Telemarketing can also antagonize customers because telemarketing does not allow the customer to interact with the business organization at a time of the customer's choosing.

Contact management software packages are typically database software that hold various data regarding a customer or prospective customer. The stored information often includes name, address, telephone and fax number, e-mail address, key contacts, etc. Other information may include status, media source, notes or comments each time contact occurs, follow-up events or actions, and an individual sales person's calendar which can store and display the follow-up events. Contact management capabilities are required to maximize the maintenance and growth customer relationships, but such capabilities are not sufficient. Such tools are administrative in nature, and do not typically provide much insight into the planning of customer interactions or the appropriate follow-up to those interactions. Contact management software is a means to convert a calendar and address book into an electronic format so that data is easily accessible. Contact management software does not typically incorporate any form of marketing expertise or any other form of embedded intelligence. Reliance solely on contact management tools will result in the under-utilization of marketing and relationship building activities with customers.

Direct mail can be used to provide various literature and information to customers and prospects. These mailings are sometimes mass mailings, but direct mail can also be used as a result of an individual inquiry by a customer or prospective customer. Direct mail can be expensive to use, and it is often inconvenient for the customer to provide feedback since the customer would be required to either make a phone call or send a response in the mail. It is generally more convenient to respond to an e-mail than it is even to mail a pre-addressed postcard containing customer feedback. Response rates with direct mail are low, and without customer feedback, it is difficult to build relationships with customers.

Customer Relationship Management (“CRM”) embodies the philosophy that a positive relationship with a customer or prospect is necessary to maintain and grow the sales of a business. All departments and employees can play a role in the development and maintenance of the relationship, i.e. sales, quality control, production, engineering, accounting, and customer service. Expensive and sophisticated computer applications have been developed that manage the relationship of a customer with each department within a company. The functionality of these systems often includes some combination of the techniques discussed above.

Many companies utilize some or all of these selling techniques. However, only large companies use CRM because a CRM requires large and sophisticated computer systems, extensive employee training, competent information technology personnel, and customized solutions. An entire industry has developed to consult with large companies to develop their CRM capabilities. The costs of these capabilities are generally beyond the means of small and mid size entities, and beyond the means of other organizations such as schools, churches, community groups, and other nonprofit entities. Thus, there is a need for software and computer systems embodying CRM principals and tenets which can be economically utilized by businesses regardless of size. A less expensive and complex means for achieving CRM functionality may also allow a wide variety organization types outside of traditional businesses, to utilize the advantages of CRM. School systems, churches/religious groups, community groups, physicians, political campaigns, and any other type of entity or organization concerned with building on-going relationships with people can make effective and fruitful use of inexpensive and relatively simple CRM functionality.

A school system will have different types of interactions than a vendor of electronic equipment. Thus, it is desirable for a CRM system to be highly and easily customizable by the user. Database structures are typically horizontal. To add a new characteristic tracked by a CRM system with such a data structure often requires that new database column be added for all rows on the database. It is desirable for a CRM system to utilize a vertical database structure. Such a system may allow new data fields to be added as easily as adding an item at the bottom of a list.

Existing CRM systems also fail to fully utilize customer feedback. It can be desirable for numerical values to be assigned to customer feedback using entirely customizable criteria and numerical thresholds. Different feedback with customers can then automatically result in entirely different follow-up activities, with different customers being treated differently, and in accordance with marketing expertise embedded in the system. It is desirable that any question and answer format incorporate a decision tree to automatically process communications with the customer(s). The number of different branches on the decision tree can be as numerous as desired in the particular context.

### SUMMARY OF THE INVENTION

The present invention relates in general to customer relationship management (“CRM”) systems. In particular, the present invention relates to a highly customizable CRM system that can utilize interactive and iterative scripts to interact with customers. By soliciting information from the customer, the system facilitates effective future efforts by an organization to build a relationship with the customer. Customer responses can be evaluated, stored in a database, and ranked. These responses can be use to automatically trigger the scheduling of future follow-up activities on the basis of intelligence incorporated into the system in the form of decision trees.

The system allows users to create customizable “scripts” for interacting with customers. Customer responses to such scripts can be stored and assigned a numerical value or ranking according to the goals of the marketing entity. Aggregate numerical values can be assigned to the customer as a whole, incorporating the various individual responses provided by the customer. Customer feedback can also be the basis of future scripts. The system can support large decision trees of scripts, utilizing customer feedback to truly explore the particular needs and interests of the customer. Predetermined thresholds of aggregate customer ratings can result in automatically scheduled future events. By embedding intelligence into the invention in the form of scripts and decision trees, the marketing experience of the most experienced personnel can be maximized, while those with little or no experience need only enter data and rely on the system to determine the next step in the marketing process. Scripts and decision trees can be fully integrated so that the creation of a script is the defining of a decision tree with respect to the questions, answers, and numerical values relating to that script.

The system can use a standard horizontal database table structure, but a vertical structure is preferred. A vertical structure provides the ability to add database table attributes by simply adding to a list rather than requiring an information technology specialist or database administrator to physically add a column to a database table when the database table already contains potentially hundreds, thousands, or even millions of pre-existing database rows without any data for the additional column. A vertical structure can maximize the ability of a user to customize the invention. A preferred embodiment of the invention can include a header database table, a script database table, a follow-up database table, a script total database table, a script answer database table, and a calendar database table. The flexible database structure can support the ability to store in a single database table, what would require multiple customized horizontal database tables in the existing art. As a result of the highly customizable database, it is easier to capture a wider range of information that is desirable from a marketing or business point of view. The underlying database structure can thus turn the system's database into a valuable and extremely flexible report generating tool as a result of the increased data storage capabilities. For example, the system can be a powerful forecasting tool aggregating information received from individual responses.

The system can be used in the context of an application service provider (“ASP”) relationship. Such a relationship may facilitate the creation of scripts database by the ASP allowing any individual marketing agent to provide a library of pre-existing scripts to a user. A common library of scripts can provide a good starting point for the development of customized scripts. An ASP delivery mechanism is a preferred embodiment of the invention, but it is not required. Alternative embodiments can also incorporate the concept of a library of scripts from which a user can begin building their own particular scripts.

Various aspects of this invention will become apparent to those skilled in the art from the following detailed description of the preferred embodiment, when read in light of the accompanying drawings.

### BRIEF DESCRIPTION OF THE DRAWINGS

In the drawings:

FIG. 1 is a high-level flowchart disclosing some of the processes of the system, and some of the elements processed by the system.

FIG. 2 is a high-level flow chart illustrating the flexibility of the system with regards to rule setting, and the potentially perpetual nature of the customer relationships.

FIG. 3 is a block diagram disclosing a script subsystem, a feedback processing subsystem, and an event scheduling subsystem, and the interactions of those three subsystems with a library of scripts and various incarnations of feedback analysis.

FIG. 4a is an example of a prior art database using a horizontal column structure.

FIG. 4b is an example of a database table using a vertical structure to facilitate flexibility.

FIG. 5a is an example of a prior art database using a horizontal column structure, and the necessity of changing the table definition to add a column to the table.

FIG. 5b is an example of a database table using a vertical structure to allow the adding of a data field without needing to alter table or column definitions.

FIG. 6 is a vertically-based database table definition for a scripts table.

FIG. 7 is an example of a decision tree utilized by scripts in the system to navigate from question to question, to generate weights for certain answers, and to automatically generate follow-up activities.

FIG. 8a is an illustration of a potential user interface allowing a skilled business person to define the decision tree with respect to customer rating and a predefined boundary threshold.

FIG. 8b is an example of a decision tree or script that could be used as follow-up decision tree or script for the script displayed in FIG. 7.

FIG. 9 is an integrated and detailed flowchart showing a loop from script activation through follow-up events, and back again.

FIG. 10 is an integrated and detailed flowchart showing how the numerical value associated with a particular answer can result in an additional independent stream of scripts, feedback analysis, and follow-up events.

### DETAILED DESCRIPTION OF THE PREFERRED EMBODIMENT

A. Overview of the System and Method

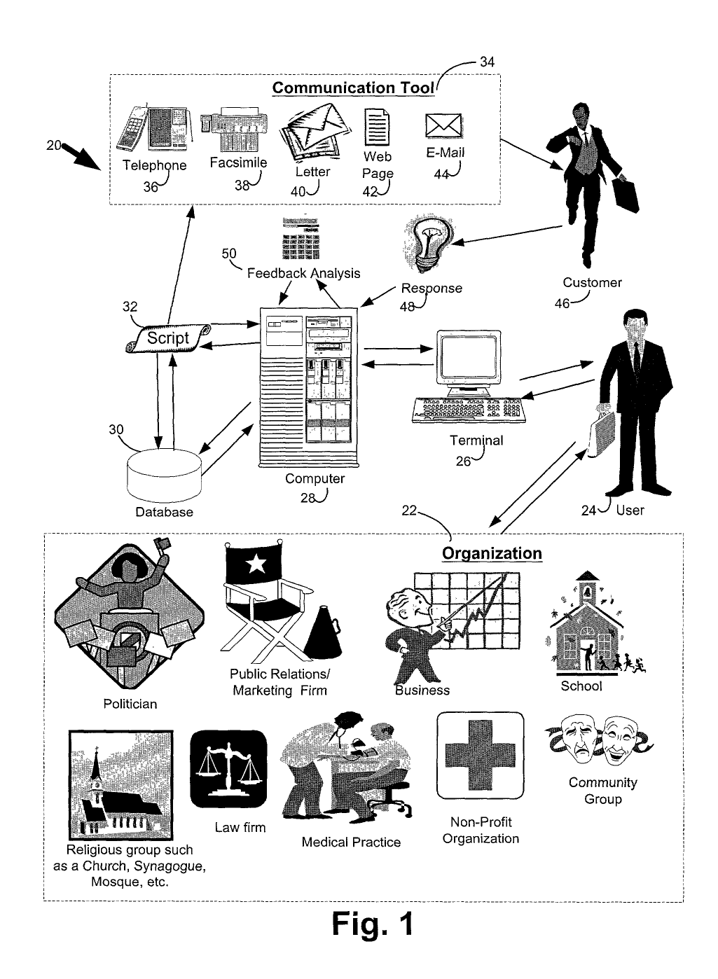

Referring now to the drawings, illustrated in FIG. 1 is a high-level view of some of the elements and processes of a customer relationship management system 20. The system 20 facilitates the ability of an organization 22 to develop and cultivate relationships with a customer 46. There are numerous types of organizations 22 that can use the system 20. Organizations 22 are defined broadly to include potentially any group or individual interested in cultivating relationships with other individuals or other groups. Similarly, the term customer 46 is broadly defined to include any person, group, or organization in an existing or potential relationship (collectively “customer”) with an organization 22.

Businesses can use the system 20 to deepen existing client relationships while at the same time facilitate the development of new or old leads for potential new customers. Politicians can use the system 20 for building relationships with voters and constituents. Public relations firms and marketing firms can utilize the system 20 on behalf of themselves as well as their clients. Religious organizations can use the system 20 to cultivate relationships with their members and potential members. Law firms can use the system 20 to manage their client relationships and to explore new potential client opportunities. A medical practice can similarly use the system 20 to build ongoing relationships with patients to facilitate return visits, and to explore relationships with potential patients. Non-profit organizations can use the system 20 to raise money and generate volunteers and supporters for their particular goals and activities. Community groups can use the system 20 to inform community members of various activities, and to seek increased participation from members. Schools can use the system 20 to develop particular areas of interest on the part of students, parents, and others in the community.

Organizations 22 can interface with the system 20 through a user 24. The user 24 can be a member of the organization 22, or someone hired by the organization 22 to use the system 20 on behalf of the organization 22. Many aspects of the system 20 can be automated, as discussed in greater detail below. Marketing expertise can be built into the system 20 so that the user 24 does not personally need to possess such expertise, while still being able to use the expertise embedded in the system 20. The user 24 can access the system 20 through a terminal 26. In a preferred embodiment, the terminal 26 is any device capable of accessing the Internet. In alternative embodiments, the terminal 26 can be any device capable of networking with a computer. In a “stand alone” embodiment, the terminal 26 is a computer 28 which houses the software used by the system 20. Stand alone embodiments are sometimes not as useful as networked embodiments because stand alone embodiments limit the number of users 24 that can access the system 20. A web enabled embodiment permits potentially all of the members of an organization 22 to access the system 20 as users 24 at one time, or at their conveniences. A web enabled embodiment also permits a user 24 to access the system 20 from any location in which the world wide web can be accessed.

In a preferred embodiment, a computer 28 separate from but connected to the terminal 26 can be used to store the software and/or hardware used by the system 20. The software used by the system 20 to facilitate customer 46 relationships can be called “front end” software because it is the software which is directly accessed by a user 24. The computer 28 is preferably server. If the server 28 is accessible to users 24 over the Internet, the server 28 can be maintained by an application service provider (“ASP”), a company that provides hosting and distribution services to organizations 22. An ASP may also provide additional services for organizations 22 such as training in the use of the front end software used by the system 20, and consulting in appropriate instances in the use of CRM technologies and strategies. By contracting with an ASP, an organization 22 can reduce costs, improve security, and take part in the enhancement efforts of the ASP. The ASP can also assist an organization 22 in setting up the system 20 for the first time, a process which involves creating decision trees and scripts as discussed in greater detail below. A preferred embodiment of the invention uses an ASP to develop, maintain, control, and enhance the front end software residing on the server 28. The front end software can be written in virtually any programming language, but is preferably written in a commercially available and commonly used language such as Java or Visual Basic. The programming language of the front end software is also preferably object-oriented, and easy to use with respect to creating a web or graphical user interface for the front end software.

If an ASP or other third party (collectively “ASP”) manages the computer 28, and the organization 22 wants to use the organization's 22 web site 42 for providing customers 46 access to scripts, a link to the ASP web site can be placed on the organization's web site so that a customer 46 can visit the ASP web site 42 from the organization's web site. Such a link could be in the form of an icon, hypertext, or any other mechanism for navigating web pages. The transfer of the customer 46 to the ASP web site from the organization's web site and back to the organization's web site can be hidden from the customer 46 by having the ASP web site resemble the organization web site in some or all material respects. Specific web interface scripts can be generated for such an embodiment.

The computer 28 is in direct communication with a database 30. In a preferred embodiment, the database 30 is a commercially available SQL relational database such as those provided by vendors such as ORACLE® or MICROSOFT®. Alternative embodiments may utilize object-oriented, hierarchical, or other forms of data management, including the use of flat files. The database 30 is preferably modular and flexible, so that it can be easily duplicated and customized for potentially numerous different organizations 22, further reducing start-up costs. All of the data saved by the system 20, including scripts and other types of information described below, can be saved in the database 30. In an ASP embodiment, there are typically three types of users 24, and thus there are three types of users 24 who can interact with the database 30. One can be an ASP application specialist, a user 24 who sets up each new account and customizes the system 20 to the organization's 22 specifications, including the generating of decision trees and scripts, as described below. A second type of user 24 are the sales and marketing personnel (including their support staff) who can use the system 20 to facilitate the development and management of customer 46 relationships. A third type of user 24 is the organization's 22 information technology support personnel who control access to the system 20, report generation, the downloading of data, etc. by the business users 24 of the system 22.

In a preferred embodiment, the database 30 can use database tables structured in a vertical way (vertically-based database table) as opposed to a typical database which uses horizontal columns. Vertically-based database tables are discussed in greater detail below.

One type of information stored on the database 30 is a script 32. Scripts 32 are questions to be communicated to a customer 46. A script 32 can contain one or more questions. Scripts 32 can include answers by the customer 46. A script can have multiple choice answers (which includes but is not limited to true/false answers, yes/no answers, and answer options 1,2, or 3, etc.), while other questions may require or allow open-ended data input from the customer 46 being questioned. A library of scripts 32 can be stored in the database 30. By collecting customer 46 information from scripts 32, which are reusable and customizable, there is no need for extensive and expensive customized databases. The ability to use a library of scripts 32 can produce savings in start-up costs, maintenance costs, training costs, and subsequent development or enhancement costs. Scripts 32 may be created quickly and easily by non-technical users 24 for almost any activity within an organization 22. Vertically-based database tables can make it particularly easy for non-technical business people and support staff to generate scripts 32 and otherwise use the capabilities of the system 28.

Scripts 32 need to be communicated to a customer 46 in order for the scripts 32 to be answered by the customer 46. The system 20 can support numerous communication tools 34 in which to communicate with the customer 46. With respect to communicating a script 32 to a customer 46, an e-mail 44 is the preferred communication tool 34. An e-mail 44 is respective of the customer's 46 time, allowing the customer 46 to respond when it is convenient to the customer 46. E-mail 44 also facilitates a greater degree of automation, allowing scripts 32 to be sent and received in a fully automated fashion, if desired. An e-mail 44 can be an affirmative form of communication that does not require the customer 46 to approach the organization 22, as is true with passive communication tools 34 such as a web page 42. E-mails 44 tend to have higher response rates than other communication tools 34 utilized for marketing purposes. From a technical standpoint, web pages 42 may best facilitate automatically incorporating the customer's response into the system 20. An e-mail 44 containing a link to a web page 42 or the HTML itself can be a preferred means for distributing and receiving scripts 32.

The system 20 can facilitate communications with customers 46 through scripts 32 and through other forms, such as calling a customer on the phone 36, sending a communications via facsimile 38, mailing a letter 40 or brochure, or any other form of communication tool 34. Other communication tools 34 can be utilized in a manner following the dictates of a script 32, although certain communication tools 34 such as phone calls 36 may require a certain degree of flexibility.

Customers 46 can give a response 48 back to the system 20 and the organization 22 using any one or more of the communication tools 34. One of the purposes of communicating with a customer 46 is to learn information about the customer 46. Learning information about the customer 46 is facilitated by receiving feedback from the customer 46. A customer 46 can respond to a phone call 36, to a chance person to person meeting on the street, or any other form of communication tool 34. The script 32 used to interact with the customer 46 can similarly utilize any communication tool 34. A response 48 by the customer 46 can come in many different forms, but the system 28 is capable of tracking and recording all such responses 48. A response 48 in the form of an e-mail reply 44 can be automatically or manually inputted into the computer 28 with or without any human intervention by the organization 22. Responses 48 in the form of data entry by a customer 46 on a web site 42 can similarly be incorporated without any human intervention. A phone conversation 36 can be inputted into the system 20 by a user 24 entering in the relevant data into the terminal 26. Facsimile 38 and written letters 40 from a customer 46 can use data entry by the user 24 to be inputted into the system 20, or can potentially be scanned into an electronic format, and then processed automatically by the system 20 without the need for human intervention. The system 20 can benefit from integration with many of the efforts to create paperless office environments.

Response information 48 can be inputted to the computer 28, and can then be subject to a feedback analysis 50 by the system 20. The different types of analysis that can be performed by the system 20 are discussed in greater detail below. Sophisticated analyses can be performed on customer 46 responses 48 to facilitate the implementation of a decision tree approach with customer 46 communications. Different responses 48 result in different follow-up behavior and different subsequent scripts 32 being communicated to different customers 46. In other words, the system 20 can support a sophisticated and targeted approach with respect to each customer 46. Scripts 32 and the decision tree analysis incorporate marketing and communication expertise that can then be utilized by any user 24 of the system 20 to properly pursue follow-up activities appropriate to the particular responses 48 of the customer 46. It does not matter whether or not such a user 24 personally possesses any such marketing or communication expertise, because the intelligence is embedded into the system 20. The cycle between script 32, response 48, analysis 50, back to follow-up and another script 32 can be perpetual, as customer 46 relationships are ongoing relationships when conducted in a beneficial manner. A successful transaction need not, and preferably does not, result in a termination of the cycle, as repeat customers 46 can be important to businesses and other types of organizations 22.

B. Highly Customizable Rule-setting

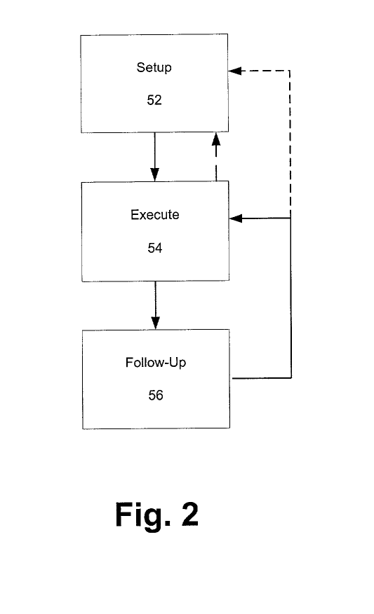

FIG. 2 discloses a high level flow chart illustrating the highly flexible nature of the system 20. The first stage in an organization's 22 use of the system 20 is a setup process 52. In prior art systems and methodologies, there are many obstacles in the setup process 52. Business people often do not have the technical expertise to configure a prior art system according to the business needs of an organization 22. Technical people rarely have the business expertise to know what the business needs of the organization 22 are with respect to managing customer relationships. Thus, modifying an existing prior art system is very expensive. Similarly, there are many obstacles to building a prior art system from scratch. Even if such a system is built to the specification of the particular organization 22, that does not mean that the underlying architecture of the system would make it easy for the organization 22 to subsequently change or modify the system that was created. The system 20 of the present invention is easy to modify and can easily incorporate new or modified logic in the form of new or modified scripts 32 and decision trees. The flexibility of the system 20 supports the simplicity of the process in the figure.

The setup process 52 involves creating scripts 32 to be used by an organization 22. If an ASP other third party is involved in the process, new scripts 32 can be easily generated from existing scripts 32 in the possession of the ASP or other third party. It can sometimes be easier to modify an existing script 32 than it is to create a script 32 from scratch. It can be helpful for the business people in the organization 22 to look at sample scripts 32 and sample decision trees during the setup process 52 to see the types of decision trees that can be embedded in a script 32, and the ability of the system 20 to incorporate sophisticated marketing intelligence. Creating scripts 32 is described in greater detail below.

The setup process 52 can also involve basic data entry operations, such as entering names and contact information in a database 30. If the organization 22 has an existing contact management system, the setup process 52 can integrate the preexisting system with the customer relationship management system 20.

After enough of the setup process 52 has been completed in order for the system 20 to start facilitating communications with customers 46, the system 20 can then begin an execution process 54. The execution process 54 can consist of sending scripts 32 to customers 46 and receiving responses 48 from those customers 46. The system 20 takes the response 48 information, and generates a follow-up process 56 including additional communications and scripts 32. The follow-up process 56 may also include the scheduling of events such as user reminders, phone calls 36, facsimile communications 38, mailings 40, e-mails 44, web page announcements 42, face-to-face meetings with customers 46, or any other form of interaction with a customer 46. A follow-up process 56 can potentially loop perpetually with the execution process 54. Customer 46 communications can potentially allow the system 20 to perpetually exchange information with a customer 46. During any point in the execution process 54 or the follow-up process 56, the setup process can be added to or modified, allowing the user 24 to modify the intelligence underlying the system 20 Dotted lines in the figure leading from the execution process 54 and the follow-up process 56 and pointing to the setup process 52, indicate that database fields, scripts 32, decision trees, feedback analysis 50, and other aspects of the system 20 can be easily modified or created at any time.

C. Three Interconnected Subsystems

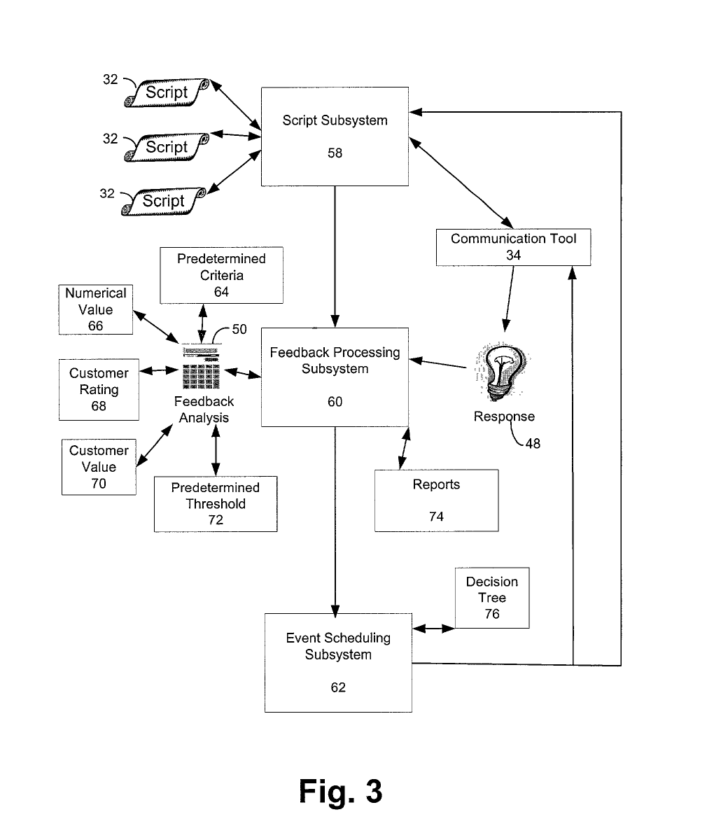

FIG. 3 discloses a preferred embodiment of the system 20 that can utilize three interconnected subsystems. A scripts subsystem 58 is used to create and maintain a library of scripts 32 using the database 30. The scripts subsystem 58 can also be responsible for use of the various communication tools 34 used to communicate with customers 46. The database 30 can be directly connected to each subsystem in the system 20.

Responses 48 are processed by a feedback processing system 60, although the answers in the response 48 can constitute part of the script 32. The feedback processing subsystem 60 houses the feedback analysis 50 used by the system 20. As described in greater detail below, each response 48 by a customer 46 can be associated with a weight or numerical value 66 associated with that customer 46. If a particular answer by the customer 46 makes the customer 46 a more desirable prospect for the organization 22 (for example, the customer 46 may have answered yes to the question of whether the customer 46 is interested in making a purchase within the next seven days), a greater numerical value 66 can be attributed to a particular answer. Correspondingly, an undesirable answer can result in a zero numerical value 66, or even a negative numerical value 66 (for example, a parent of a student at a school may be moving to a different city in a week). The intelligence used to make such distinctions is set in a predetermined criteria 64, which can be embedded into the system 20 by users 24 particularly skilled in marketing, sales, and customer development, while allowing those persons not as skilled to benefit from the embedded intelligence as users 24 of the system 20. The predetermined criteria 64 can be changed as desired, and can be incorporated directly in scripts 32 and decision trees as described in greater detail below.

In addition to the numerical value 66 associated with a particular response 48, a value can also be associated with the overall aggregate responses 48 of a particular customer 46. A customer value 70 can represent a numerical value relating to the overall customer 46. Customer value 70 can be determined solely by the aggregation of the values 66 associated with the responses 48 of the customer 46. In a preferred embodiment, the customer value 70 is more than the sum of the numerical values 66 associated with responses 48, and represents a more holistic view of the customer 46. Customer value can preferably incorporate the feedback 48 from multiple scripts 32. The overall customer value 70 can be compared to a predetermined set of thresholds 72 to derive a customer rating 68. The predetermined thresholds 72 represent intelligence embedded into the system 20; intelligence that can be directly embedded into scripts 32 and decision trees 76. The customer rating 68 can allow the system 20 to make nuanced decisions with regards to different customers 46. For example, a project with a large economic value and a short time frame for completion would be rated differently than a small project with a long time for completion. The customer rating 68 can impact the automated decisions made by an event scheduling subsystem 62, described in greater detail below. The customer rating 68 can determine what is the next action or set of actions with respect to that customer 46. The embedded intelligence incorporated into the customer rating 68, customer value 70, and the predetermined threshold 72 can be changed, added, or deleted as desired.

The feedback processing subsystem 60 stores the feedback analysis 50 in the database 30. The database 30 may then be used to generate a wide variety of different reports 74. In some embodiments of the system 20, the feedback processing subsystem 60 can generate reports 74 by accessing the database 30. In alternative embodiments, other computer software can be used to interface with the database 30, and generate the reports 74. Scripts 32 can be highly flexible, and may facilitate responses 48 relating to any subject or department. For example, if a script 32 includes a question about future purchases and the amounts of those purchases, the system 20 can be used to generate a sales forecast in the form of a report 74. Other types of response 48 can also be saved in the database 20 and potentially used by the system 20 in useful ways. Vertically-based database tables can facilitate the ability of users 24 to capture important business data that can then be used to generate reports 74. Vertically-based database tables are described in greater detail below.

The event scheduling subsystem 62 allows the system 20 to automatically schedule, and in some cases trigger (e.g. template e-mail follow-ups that do not require human intervention), follow-up events. The event scheduling subsystem 62 can provide the advantage of automatic follow-up. The response 48 to individual questions and customer ratings 68 can be used by the event scheduling subsystem 62 to automatically schedule one or more follow-up events based using the intelligence incorporated into the system 20 in the form of a decision tree 76. Intelligence can be inputted into the decision tree 76, allowing users 24 without marketing, sales, or customer development expertise, to utilize the expertise of others, while enforcing a rigorous and sophisticated methodology for following up with customers 46.

The following is an example of the manner in which the three subsystems can work together to help manage customer relationships:

Step 1: A prospective customer 46 contacts a salesperson at the company 22. The salesperson 24 “kicks off” a script 32 called New Prospect. The questions in the script 32 are asked and the responses 48 are input into the database 30. The customer 46 feedback is analyzed and the customer is rated. If the rating is high, the prospect customer 46 is scheduled for a follow up phone call 36 and meeting. If the rating is low, as assumed in this example step two as described below can be performed.

Step 2: A piece of literature, with an accompanying cover letter 40, could be scheduled for the next day. A follow up telephone call 36 could be scheduled for fourteen days. Both events could automatically appear in the calendar of the appropriate salesperson 24 and step three would be performed.

Step 3: The next day the letter and literature would be sent. In fourteen days, a follow up telephone call 36 would be made. This call would “kick off” a new script 32 called 1^{st} Follow Up Script 32. Here, a series of questions would be asked to determine if the prospective customer 46 received the literature previously sent and to determine if the prospective customer 46 should be re-rated. If, for some reason, it is determined that the literature was not received, it would be automatically be scheduled for re-sending. If, on re-rating, the prospective customer 46 rated high, a follow up phone call and meeting would be scheduled as well as other events. If not, the prospective customer would be scheduled for a follow up phone call in 90 days. That event could automatically be placed in the calendar of the appropriate salesperson and step four would be performed.

Step 4: Step 3 can be repeated continuously, until the prospective customer 46 is rated high enough to be scheduled for follow-up phone calls 36 and meetings or the salesperson 24 determines that the customer 46 should no longer be tracked.

D. Vertically-based Database Tables

Vertically-based database tables can provide the system 20 with beneficial flexibility because such a structure can facilitate the ability to create new types of data fields in a relatively easy manner. A vertically-based structure allows business goals to be met without requiring specialized expertise of a database administrator (“DBA”) or other information technology specialist.

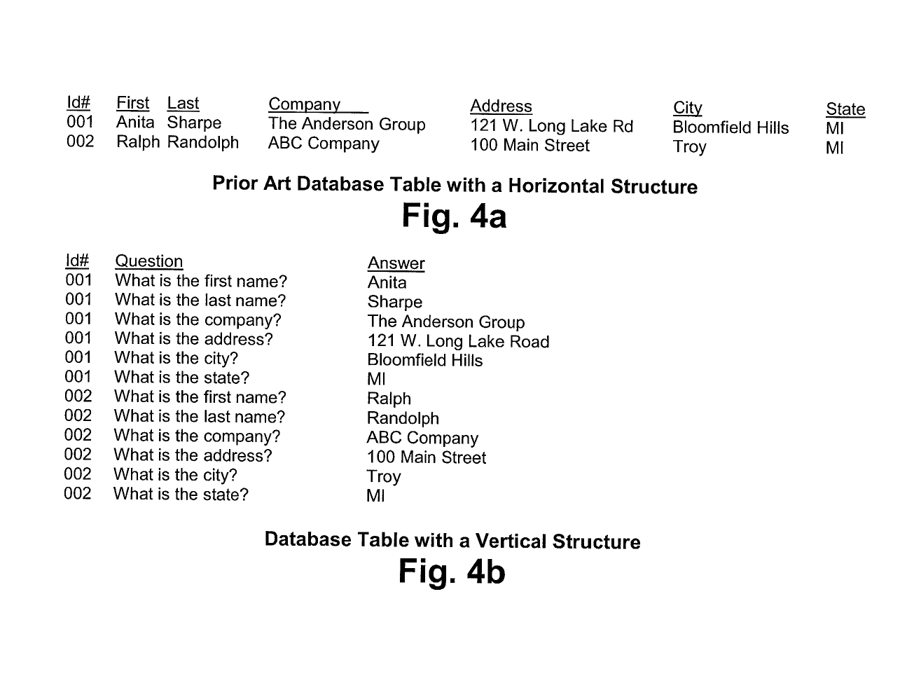

FIG. 4a is an example of a prior art database table using a horizontal column structure. Different categories or types of information are represented by different columns, which are placed horizontally along the table. Database management systems create certain relationships between the various columns in the database, and such relationships can make it difficult for a new column to be added to a table after a table has been populated with potentially hundreds, thousands, or even millions of rows.

FIG. 4b is an example of the exact same data being stored in a vertically-based database table format. Three columns are used to store all of the information. In contrast, the table in FIG. 4a requires 7 columns to store the information. As will be illustrated and described below, a vertically-based structure can more flexibly adapt to the desire to create new fields on a table. A vertically-based database format uses additional rows to compensate for having fewer columns. Rows can be added or deleted from a database through routine use, unlike columns which often require a DBA or other information technology specialist.

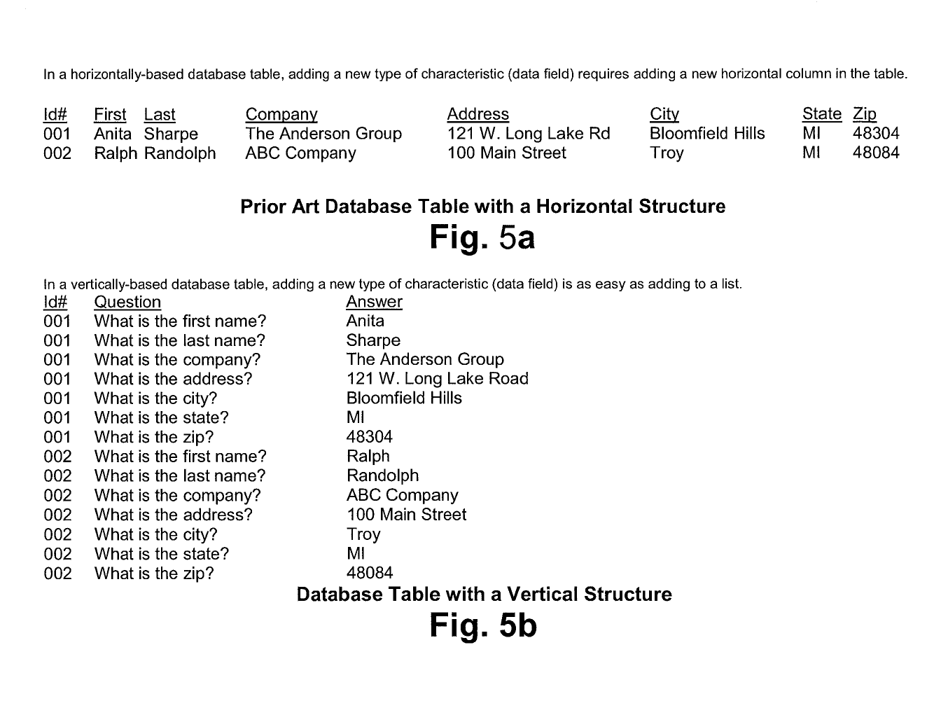

FIG. 5a is an example of the prior art database table in FIG. 4a, after zip code information is added to the table. As viewable from the figure, the addition of zip code information required the addition of a new database column. Such a modification usually requires the work of a DBA or other technical specialist. Adding a column in such a fashion can have undesirable effects on the already existing rows in the database 30 that do not have data for that particular column. The reluctance of a DBA to add columns, or the inability of a user 24 to add a column on his or her own hampers the ability of a user 24 to track and store desirable information.

FIG. 5b is an example of adding a database “column” in a vertically-based database table. Zip code information was added to the table without physically adding a column to the database table. No change was made to the three columns in the database. The figure is an illustration of how a business person can expand the data storing capacities of the database 30 without needing to ask a technical specialist to perform extra work, and by avoiding the potential complications when table definitions and relationships are changed. Such flexibility supports the ability to capture more business information that can be utilized to further the relationship between organization 22 and customer 46.

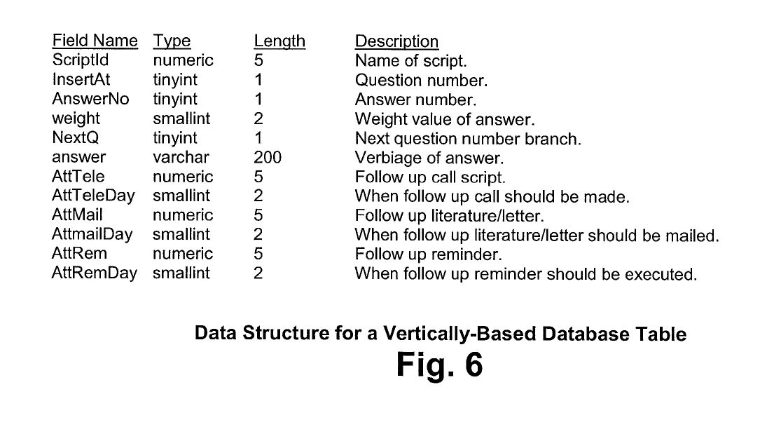

FIG. 6 is a database table structure in a preferred embodiment of the invention. The particular database table shown is a script database table. Use of such a structure provides the flexibility described above. Alternative embodiments of the invention can use a standard horizontal database structure, but such embodiments are not preferred. It is particularly beneficial to incorporate a vertical-based script database because the types of questions can vary widely, with respect to particular customers 46, particular situations, and particular organizations 22 (in the case of an ASP embodiment). Script 32 flexibility is desirable to maximize the flexibility of the system 20.

Within the database 30 there are multiple tables to hold and display data. The tables and field names may be anything that is convenient. Different embodiments can utilize different combinations of database tables. In a preferred embodiment, the following six tables can be included.

First, a header table. The header table can hold information about each new Customer 46 contact such as name, address, telephone, fax, e-mail address, status, media source from which the contact was derived, etc. Header data can be captured at the time a new contact is created.

Second, a script table. The script table can hold a series of questions and answers, i.e. a telemarketing script. Each script 32 can be given a unique script name. Responses 48 can be associated with weights or values 66, and one or more follow-up events, i.e. letters to be mailed 40, follow up telephone call 36 to be made, or staff reminders, etc. Events can also be associated with dates for which the events can occur. Responses 48 can determine the next question to be asked within the same script 32, or can determine which follow-up script 32 is subsequently invoked for the particular customer 46 providing the responsive response 48. The database 30 can hold all of the above in a single table or multiple tables. The fields can include Contact, Script Name, Question Number, Question, Answer Number, Answer, Next Question Number, Weight (or Value), Type of Answer (alpha numeric, date, numeric, money, text), Type of Follow up Event, Timing of Follow up Events. Data for Scripts is created by the person(s) creating the scripts. Typically, only the ASP Administrator will create scripts 32 in a preferred embodiment, but the database 30 may be configured to allow anyone to create scripts 32.

Third, a Letters/Follow up Telephone table. These tables can hold a list of letters 40, e-mails 44, and names of scripts 32 to be selected from when creating follow up events as described above. Data can be created by the organization's Organization Administrator and can be available to be selected from when creating new scripts 32.

Fourth, a Script Total table. The Script Total table can hold data used to qualify, or rate a Contact. Here various ratings can be determined as a result of the sum of the values or weights of the answers selected by a Contact when answering scripted questions. Fields can include Contact, Script, Values, Total Values, Rating Range of Values (Predetermined Thresholds), Ratings, Follow up events, Timing. The person creating scripts 32 can also create the Script Total data.

Fifth, a Script Answer table. The Script Answer table can hold the answers selected by the Contact from the available answers to each question of the script 32 and the follow up events created as a result of the answers selected. Fields can include Contact, Script, Question, Answer, Follow-Up, Event, and Timing. Data can entered into the Script Answer Table by users 24 of an organization as they record the answers to scripted questions.

Sixth, a Calendar table. The Calendar Table can hold all of the follow up events created as a result of executing scripts 32 and/or as a result of the rating 68 of the customer 46 in the Script Total Table. The fields include Organization User (the calendar owner), Contact, Event, Date the Event is to Occur, and Event Status. Users 24 in the organization 22 can update the Event Status field when the event is completed.

E. Decision Trees

Decision trees 76 preferably manifest themselves throughout the system 20. Decision trees 76 are the mechanisms by which the system 20 can treat different customers 46 differently, on the basis of the responses 48 provided to the system 20. In a preferred embodiment, the decision tree 76 can be embedded in a script 32 itself, while still being able determine the interactions, sequencing, and relationships between different scripts 32.

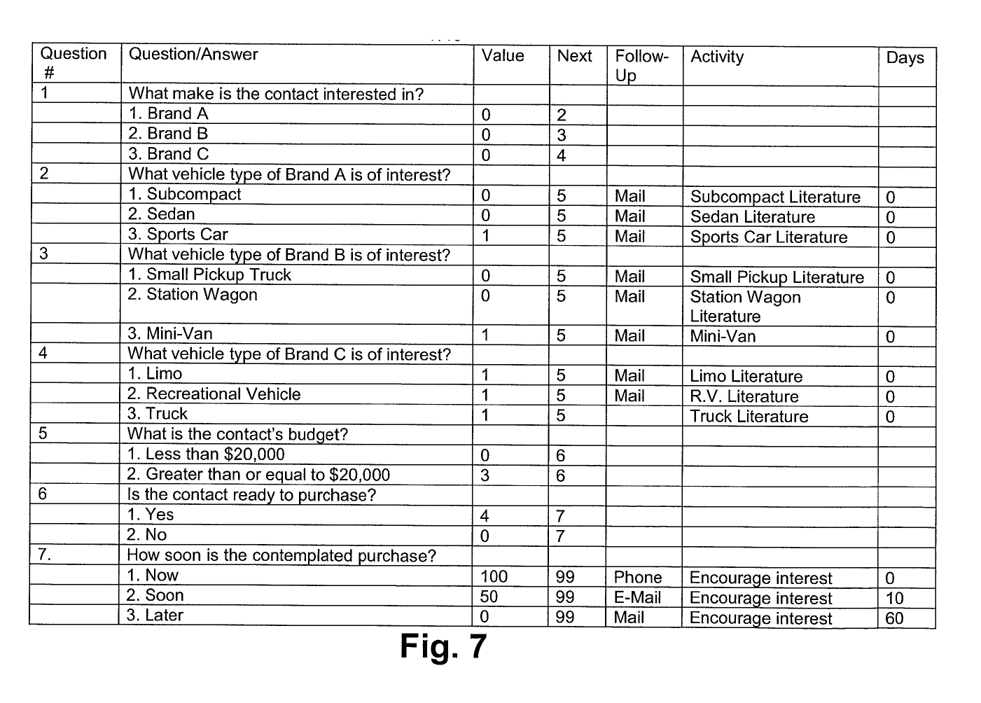

FIG. 7 is an example of a decision tree 76. The system 20 using the decision tree 76 in FIG. 7 is configured to help support the selling of automobiles; the business of the organization 22. Question 1 asks the customer 46 to identify a certain make of a vehicle. A list of three brands is provided. The organization 22 selling the vehicles does not have a preference as to the brand of vehicles sold, so there is no numerical value 66 associated with any particular response. However, the decision tree does determine which question will next be asked. If the customer chooses Brand A (Answer 1 for Question 1), the next question asked relates to Brand A; “What vehicle type of Brand A is of interest?” Similarly, choosing Brand B (Answer 2 for Question 1) will send the customer 46 to Question 3: “What vehicle type of Brand B is of interest?”. Accordingly, choosing Brand C (Answer 3 for Question 1) will send the customer 46 to question #4 “What vehicle type of Brand C is of interest?” Each of the various options with respect to Questions 2, 3, and 4 relate to particular types of vehicles. In all cases, the sending of product information in the mail 40 is an activity triggered by the particular selection. In each case, the product literature is targeted so that the literature relates solely and directly to the specific selection made by the customer 46. Because certain lines of vehicles are more profitable than others, different selections receive different numerical values 66. For example, sports cars, mini-vans, trucks limos, and R.V.s are high-profit sales for the organization 22. Thus, each high-profit item can be associated with a numerical value 66 greater than 0, while all other vehicle type answers are associate with a numerical value 66 of 0.

In the particular decision tree 76 displayed in the figure, the customer 46 is directed to a common set of closing questions beginning at Question 5, “What is the contact's budget?” The organization 22 may be more efficient in its pursuit of maximizing profit if it pursues leads with greater financial prospects. For example “over $20,000” customers 46 can be more vigorously pursued than “$20,000 or under” customers 46. Thus, the higher budget value has a numerical value 66 of 3 while the lower budget response 48 has a numerical value 66 of 0.

Another factor which can determine the priorities of the organization 22 is whether the customer 46 is looking to make an immediate purchase, or whether the customer 46 is looking to wait. Thus, the answers to Question 6 in the figure have two different numerical values 66. From the numerical values 66 assigned in the decision tree 76, being ready to purchase now is worth 4 points, but having a budget of over $20,000 is worth only 3 points. The priorities illustrated in the particular example decision tree 76 indicate that timing is more important than the size of the deal. Other organizations 22 and other situations may require different treatment and different priorities. The system 20 can support a highly flexible approach, and the user 24 is able to change the priorities and approaches previously incorporated in decision trees 76.

The numerical values 66 associated with the final question show that timing is of the essence for the organization 22 in the figure. A decision to purchase now is worth 100 points while a decision to make a purchase soon is only worth 50 points. A decision to purchase now will result in an immediate phone call in the activity column. A decision to purchase soon will result in an email in ten days. A decision to purchase later will result in a letter mailed 60 days after the response 48 is received.

The data in the figure is for illustration purposes only. It shows how flexible decision trees 76 and the system 20 can be with respect to the types of information processed by the system 20. The flexibility of the system 20 in allowing users 24 to create decision trees 76 to suit their business goals can be utilized to the degree desired by the particular organization 22.

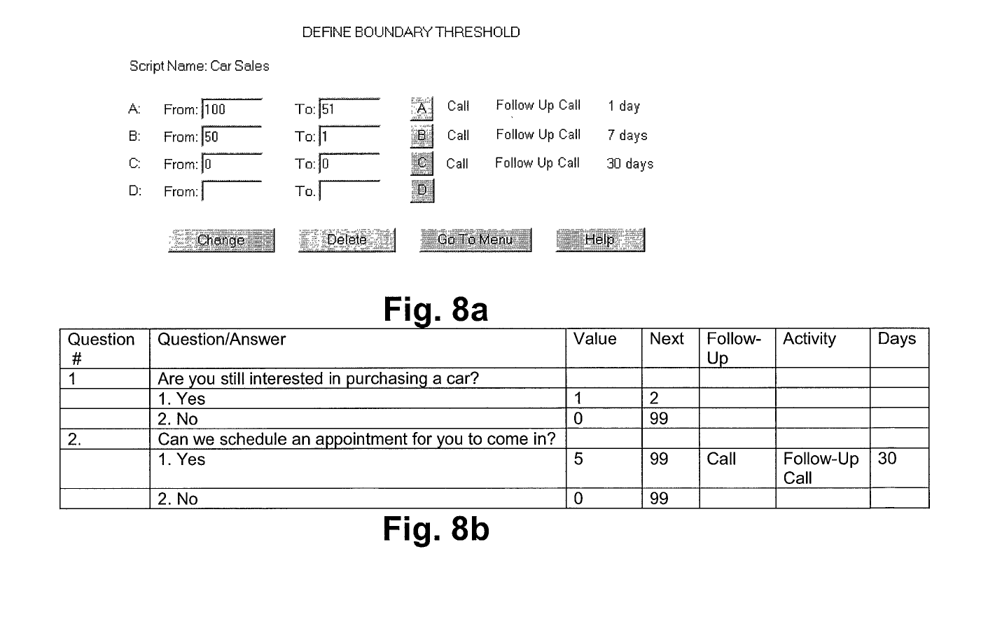

FIG. 8a is a screen print of one way in which a decision tree 76 can be created or modified by a user 24 of the system 20. The user 24 can enter the predetermined boundary threshold 72 that can be used by the event scheduling subsystem 62 to differentiate between different customers 46 on the basis of customer ratings 68 and values 70. As shown in the particular example, a rating 68 between 100 and 51 will result in high priority treatment, receiving a follow-up phone call within one day. A rating 68 between 50 and 1 will result in a follow-up phone call after 7 days. In contrast, a rating 68 of 0 will result in a follow-up phone call after 30 days have passed. Boundary threshold points can be revised as often as desired by the user 24.

FIG. 8b is an illustration of a follow-up decision tree 32 following the initial decision tree in FIG. 7, and incorporating the application of the predetermined threshold 72 in FIG. 8a. If in follow-up response 48, the customer 46 is interested in purchasing a vehicle, an appointment will be made for the customer 46 to come in. Otherwise, there is no follow-up activity planned. The system 20 does support the practice of ceasing to pursue a lead on the basis that the lead simply does not seem promising. Decision trees 76 can link virtually endless chains of scripts 32 and schedule events.

F. Comprehensive Integrated Process Flows

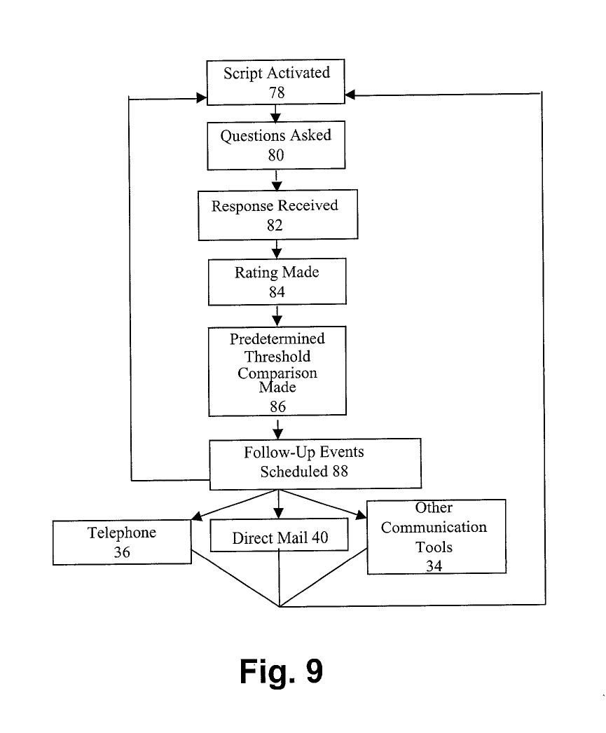

The system 20 is comprised of various subsystems and components. However, the system 20 is an integrated system 20, utilizing components such as subsystems and components in an integrated and comprehensive manner in a preferred embodiment of the invention. All subsystems and processes can interact with each other through the database 30, which can be a centralizing factor in the system 20. FIG. 9 illustrates a flow-chart of such an integrated process, without regard to components or subsystems.

A script can be activated at 78. If necessary, the desired script 32 can be created, if it does not already exist. The activation or initiation of a script 32 begins with the inputting of contact information in the database 30 relating to that customer 46. A script 32 can then be selected for activation, and the system 20 can facilitate delivery of the script 32, if the script 32 is to be delivered in an electronic format, such as an e-mail 44 or an web page 42.

Questions can be asked at 80. Questions can be an important part of the decision tree 76 because questions utilize the embedded intelligence described in greater detail above. Questions can be asked using any communication tool 34 desired. Questions are reusable, and new questions can be generated from modifying old questions. Questions may be stored in the database 30 for reuse.

Responses can be received at 82. Responses can be received using any desired communication tool 34. Responses can be associated with numerical values 66, customer value 70, and customer ratings 68.

A rating can be made at 84. The calculating of a customer rating 68 generally involves first calculating individual answer numerical values 66, computing an aggregate customer value 70, and then generating a customer rating 68 using a predetermined threshold 72 as described in greater detail above. Different methodologies can be incorporated in the system 20, and the user 24 is able to use as much or as little of the different metrics as is desired. The predetermined threshold 72 inputted in a screen such as FIG. 8a. A comparison can then be made at 86 between the predetermined threshold and the customer rating.

Follow-up events can be automatically schedule at 88. Such events are scheduled in accordance with the decision tree 76 and the response 48 provided by the customer 46. In some instances, a follow-up event can be automatically performed by the system 20, such as by sending an e-mail 44 with a follow-up script 32 on the scheduled day or at the scheduled time. Phone calls 36, direct mail 40, and other communication tools 34 are used to initiate follow-up communications with the customer 46. The system 20 can schedule these according the intelligence incorporated into the system 20.

The loop can then repeat back to the top, with the activation of a new script 32. The process stops when a lead is no longer to be pursued. In the case of a purchase decision (in the situation where the organization 22 is a business) or a favorable outcome (in the situation where the organization 22 is not a business), an organization 22 will often want to schedule follow-up activities to maintain a successful and beneficial relationship with the customer 46. In a preferred embodiment, only leads not worth pursuing are dropped from the system 20.

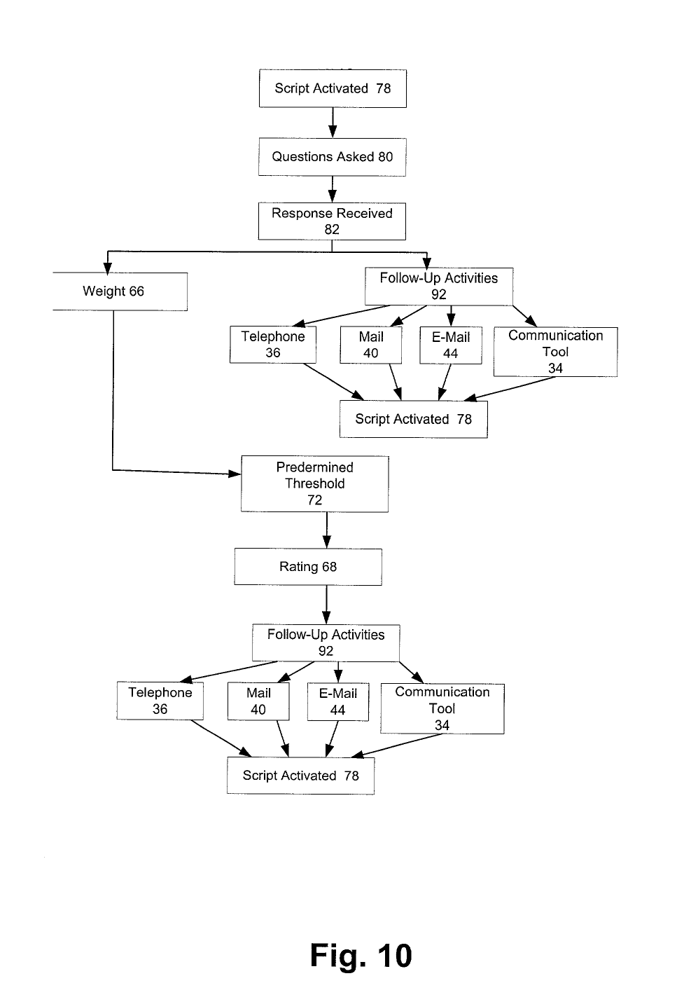

FIG. 10 discloses a similar flow chart, except that the process in FIG. 10 is more complex than the process described above in one respect. The figure discloses an example of feedback analysis 50 triggering the decision tree 76 to create an additional separate and independent loop of scripts 32, feedback 48, analysis 50, event scheduling, etc.

The beginning steps are identical with FIG. 9. A script is activated at 78. Questions are asked at 80. Responses are received at 82. In the embodiment disclosed in the Figure, the numerical value 66 of a particular answer in a response 48 generates a separate and independent series of events from the follow-up processing resulting from a comparison of the predetermined threshold 72 with a customer value 70 generated as a result of one or more responses 48 to one or more scripts 32, and the customer value 70 in comparison to the predetermined threshold 72 generate a separate and independent series of events in addition to the follow-up activities 92 resulting from the responses 48 of the user. The figure illustrates the flexibility of the system 20, in supporting the ability of certain characteristics to trigger independent additional loops of script activation, feedback analysis, and even scheduling.

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

What is claimed is:

1. A method of managing customer relationships using a computer, comprising the steps of:
creating a script of questions to be responded to by the customer;
collecting data from the customer in the form of a response to the script; and
automatically scheduling events based on the collected data.

2. A method of managing customer relationships using a computer as recited in claim 1, wherein scripts are e-mailed to the customer and the response from the customer is e-mailed to the computer.

3. A method of managing customer relationships using a computer as recited in claim 1, further comprising storing the collected data in a database.

4. The method of managing customer relationships using a computer as recited in claim 3, wherein the computer is accessible from the Internet, the database is stored in a computer, and the computer is managed by an application service provider.

5. The method of managing customer relationships using a computer as recited in claim 4, including an organization web site and an ASP web site, wherein a link to the ASP web site is provided on the organization web site, and wherein the ASP web site appears to be the organization web site.

6. The method of managing customer relationships using a computer as recited in claim 3, wherein the database incorporates vertically-based database tables.

7. The method of managing customer relationships using a computer as recited in claim 6, wherein scripts are stored in the database.

8. The method of managing customer relationships using a computer as recited in claim 6, further comprising generating reports from the collected data.

9. The method of managing customer relationships using a computer as recited in claim 8, wherein the generated reports are customizable by a user.

10. The method of managing customer relationships using a computer as recited in claim 9, wherein the generated report is a sales forecast.

11. The method of managing customer relationships using a computer as recited in claim 1, wherein a predefined decision tree determines which events are automatically scheduled as a result of the collected data, and wherein the user can modify the predefined decision tree.

12. The method of managing customer relationships using a computer as recited in claim 1, further comprising valuing a customer based on the collected data.

13. The method of managing customer relationships using a computer as recited in claim 12, further comprising ranking a customer by comparing the customer value to a set of predetermine thresholds set by a user.

14. The method of managing customer relationships using a computer as recited in claim 13, wherein automatically scheduled events are based on the collected data and customer value.

15. The method of managing customer relationships using a computer as recited in claim 13, wherein automatic scheduled events are based on the collected data and customer rating

16. The method of managing customer relationships using a computer as recited in claim 1, wherein the automatically scheduled event is the e-mailing of a script to a customer.

17. The method of managing customer relationships using a computer as recited in claim 1, wherein the automatically scheduled event is the mailing of a letter, the sending of an e-mail, or the initiation of a phone call.

18. A method of using a computer to manage the relationship between an organization and a customer, comprising the steps of:
creating a library of different scripts;
collecting data in the form of a response provided by a customer to a script;
assigning a numerical value to each customer response;
compiling the numerical values to arrive at a customer rating and customer value;
linking collected data, customer value and customer rating to future events in a decision tree;
automatically scheduling events based on the decision tree; and
storing the scripts and collected data in a database that incorporates vertically-based database tables.

19. A system for managing customer relationships, comprising:
a script subsystem, including a script and a response to said script, wherein said script subsystem generates said script and receives said response;
a feedback processing subsystem, including a response value, wherein said response value is attributed to said response; and
an event scheduling subsystem, including a decision tree and a scheduled event, wherein said decision tree relates said response to said scheduled event, and said decision tree determines the scheduling of said scheduled event by said event scheduling subsystem.

20. A system for managing customer relationships as recited in claim 19, wherein said script is an e-mail and said response is an e-mail.

21. A system for managing customer relationships as recited in claim 19, further comprising a vertically-based database table.

22. A system for managing customer relationships as recited in claim 19, said decision tree relates said response and said response value to said scheduled event.

23. A system for managing customer relationships as recited in claim 19, said feedback processing system further including a customer value, said customer value generate by said response value, and said decision tree relates said response and said customer value

24. A system for managing customer relationships as recited in claim 23, said feedback processing system further including a customer rating and a pre-defined criteria, said feedback processing system comparing said customer value to said pre-defined criteria to generate said customer rating.

25. A system for managing customer relationships as recited in claim 24, said decision tree relating said response and said customer rating to said scheduled event.

26. A system for managing customer relationships as recited in claim 19, said event scheduling subsystem further including an automatic event, wherein said scheduling of said scheduled event triggers said automatic event.

27. A system for managing customer relationships as recited in claim 26, wherein said automatic event is a sending of an e-mail comprising a script.

28. A system for managing customer relationships as recited in claim 19, said scheduled event including one of the following events:
a telephone call;
a sending of an e-mail;
a sending of a letter; or
a sending of a facsimile.

29. A system for managing customer relationships as recited in claim 19, said feedback processing subsystem including a predetermined threshold, said response value generated by comparing said response with said predetermined threshold.

30. A system for managing customer relationships as recited in claim 19, said script processing subsystem further including a vertically-based database table and a report, said script processing subsystem storing said response in said vertically-based database table and generating said report from said vertically-based database table.

31. A system for managing customer relations as recited in claim 30, wherein said report is a financial forecast.

32. A system for managing customer relations as recited in claim 19, further comprising:
a computer including said script subsystem, said feedback subsystem, and said event scheduling subsystem; and
an application service provider to manage said computer.

33. A system for managing customer relations as recited in claim 32, further comprising:
an organization web site controlled by an organization;
an application service provider web site controlled by said application service provider; and
a link on said organization web site to said application service provider web site;
wherein said application service provider web site appears to be part of said organization web site.

34. A system for managing customer relations, comprising:
a script subsystem, including a plurality of scripts and a plurality of responses to said plurality of scripts, wherein said script subsystem generates said plurality of scripts, and receives said plurality of responses;
a feedback processing subsystem, including a plurality of response values, a customer value, a customer rating, a predetermined criteria, and a predetermined threshold; and
an event scheduling subsystem, including a decision tree, a scheduled event, and a trigger selected from the group consisting of said response, said response value, said customer value, or said customer rating, wherein said decision tree relates said trigger to said scheduled event, and said decision tree determines the scheduling of said scheduled event by said event scheduling subsystem;
wherein each said response in said plurality of responses is associated with a response value in said plurality of response values in accordance with said predetermined criteria;
wherein said feedback processing subsystem generates said customer value from one or more said response values; and
wherein said customer value is compared to said predefined threshold to generate said customer rating.

35. A system for managing customer relations as recited in claim 35, further comprising a plurality of vertically-based database tables, said plurality of scripts and said plurality of responses being stored in said plurality of vertically-based database tables.
